(19) United States
(12) Patent Application Publication
(10) Pub. No.: US 2008/0224357 A1
(43) Pub. Date: Sep. 18, 2008

(54) Method for Producing Foamed Slabs

(75) Inventors: Markus Allmendinger, Edenkoben (DE); Klaus Hahn, Kirchheim (DE); Bernhard Schmied, Frankenthal (DE); Michael Riethues, Ludwigshafen (DE); Edith Antonatus, Mutterstadt (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (DE)

(21) Appl. No.: 12/064,294

(22) PCT Filed: Aug. 9, 2006
(86) PCT No.: PCT/EP06/65174

§ 371 Date: Feb. 20, 2008

(30) Foreign Application Priority Data
Aug. 23, 2005 (DE) 102005039976.2
Apr. 5, 2006 (EP) 06112265.1

(51) Int. Cl. B29C 35/08

(52) U.S. Cl. 264/402

(57) ABSTRACT

A process for producing foam moldings from prefoamed foam particles which have a polymer coating under pressure in a mold in the absence of steam, and also foam moldings produced therefrom and their use.

### CROSS REFERENCE TO RELATED APPLICATIONS

This application is a National Phase of International Application No. PCT/EP2006/065174 filed on Aug. 9, 2006, which claims priority to Application No. 102005039976.2 filed in Germany on Aug. 23, 2005 and to Application No. 06112265.1 filed in Europe on Apr. 5, 2006 under 35 U.S.C. §119; the entire contents of all are hereby incorporated by reference.

The invention relates to a process for producing foam moldings from prefoamed foam particles which have a polymer coating and also foam moldings produced therefrom and their use.

Expanded foams are usually obtained by sintering of foam particles, for example pre-foamed expandable polystyrene particles (EPS) or expanded polypropylene particles (EPP), in closed molds by means of steam. In order for the foam particles to be able to undergo further expansion and fuse together well to form the foam molding, they generally have to comprise small residual amounts of blowing agents. For this reason, the foam particles must not be stored for too long after prefoaming. Furthermore, owing to the lack of after-expandability of comminuted recycled materials composed of expanded foams which can no longer be used, only small amounts can be mixed in to produce new foam moldings.

WO 00/050500 describes flame-resistant foams comprising prefoamed polystyrene particles which are mixed with an aqueous sodium silicate solution and a latex of a high molecular weight vinyl acetate copolymer, poured into a mold and dried in air with shaking. This produces only a loose bed of polystyrene particles which are adhesively bonded to one another at only a few points and therefore have only unsatisfactory mechanical strengths.

WO 2005/105404 describes an energy-saving process for producing foam moldings. In which the prefoamed foam particles are coated with s resin solution which has a lower softening temperature than the expandable polymer. The coated foam particles are subsequently fused together in a mold with application of external pressure or by after-expansion of the foam particles as usual by means of hot steam. Here, wafer-soluble constituents of the coating can be washed out. Owing to the higher temperatures at the entry points and the cooling of the steam on condensation, the fusion of the foam particles and the density can fluctuate considerably over the total foam body. In addition, condensing steam can be enclosed in the interstices between the foam particles.

It was therefore an object of the invention to remedy the disadvantages mentioned and to discover a simple end energy-saving process for producing foam moldings having a uniform density distribution and good mechanical properties.

We have accordingly found a process for producing foam moldings from prefoamed foam particles, wherein foam particles which have a polymer coating are sintered under pressure in a mold in the absence of steam.

As foam particles, it is possible to use expanded polyolefins such as expanded polyethylene (EPE) or expanded polypropylene (EPP) or prefoamed particles of expandable styrene polymers, in particular expandable polystyrene (EPS). The foam particles generally have a mean particle diameter in the range from 2 to 10 mm. The bulk density of the foam particles is generally from 5 to 50 kg/m³, preferably from 5 to 40 kg/m³ and in particular from 8 to 16 kg/m³, determined in accordance with DIN EN ISO 60.

The foam particles based on styrene polymers can be obtained by prefoaming of EPS to the desired density by means of hot air or steam in a prefoamer. Final bulk densities below 10 g/l can be obtained here by means of single or multiple prefoaming in a pressure prefoamer or continuous prefoamer

A preferred process comprises the steps

a) prefoaming of expandable styrene polymers to form foam particles,

b) coating of the foam particles with a polymer solution or aqueous polymer dispersion,

c) introduction of the coated foam particles into a mold and sintering under pressure in the absence of steam.

Owing to their high thermal insulation capability, particular preference is given to using prefoamed, expandable styrene polymers which comprise athermanous solids such as carbon black, aluminum or graphite, in particular graphite having a mean particle diameter in the range from 1 to 50 μm, in amounts of from 0.1 to 10% by weight, in particular from 2 to 8% by weight, based on EPS, and are known from, for example, EP-B 981 574 and EP-B 981 575.

The polymer foam particles can be provided with flame retardants. For this purpose, they can comprise, for example, from 1 to 6% by weight of an organic bromine compound such as hexabromocyclodecane (HBCD) and, if appropriate, additionally from 0.1 to 0.5% by weight of bicumyl or a peroxide. However, preference is given to using flame retardants, in particular halogen-free flame retardants, exclusively in the polymer coating.

Comminuted foam particles from recycled foam moldings can also be used in the process of the invention. To produce the foam moldings of the invention, the comminuted recycled foam materials can be used in a proportion of 100% or, for example, in proportions of from 2 to 90% by weight, in particular from 5 to 25% by weight, together with fresh product without significantly impairing the strength and the mechanical properties.

In general, the coating comprises a polymer film which has one or more glass transition temperatures in the range from −60° to + 100° C. and in which fillers can, if appropriate, be embedded. The glass transition temperatures of the polymer film are preferably in the range from −30° to +80° C., particularly preferably in the range from −10° to +60° C. The glass transition temperature can be determined by means of differential scanning calorimetry (DSC). The molecular weight of the polymer film determined by gel permeation chromatography (GPC) is preferably less than 400 000 g/mol.

To cost the foam particles, it is possible to use customary methods such as spraying, dipping or wetting the foam particles with a polymer solution or polymer dispersion or drum application of solid polymers or polymers absorbed on solids in customary mixers, spraying apparatuses, dipping apparatuses or drum apparatuses.

Polymers suitable for the coating are, for example, polymers based on monomers such as vinylaromatic monomers, e.g. α-methylstyrene, p-methylstyrene, ethylstyrene, tert-butylstyrene, vinylstyrene, vinyltoluene, 1,2-diphenylethylene, 1,1-diphenylethylene, alkenes, e.g. ethylene or propylene, dienes, e.g. 1,3-butadiene, 1,3-pentadiene, 1,3-hexadiene, 2,3-dimethylbutadiene, isoprene, piperylene or isoprane, α,β-unsaturated carboxylic acids, e.g. acrylic acid and methacrylic acid, esters thereof, in particular alkyl esters, e.g. C₁₋₁₀-alkyl esters of acrylic acid, in particular the butyl esters, preferably n-butyl acrylate, and the C₁₋₁₀-alkyl esters of methacrylic acid, in particular methyl methacrylate (MMA), or carboxamides, for example acrylamide and methacrylamide.

The polymers can, if appropriate, comprise from 1 to 5% by weight of comonomers such as (meth)acrylonitrile, (meth)acrylamide, ureido(meth)acrylate, 2-hydroxyethyl(meth)acrylate, 3-hydroxypropyl(meth)acrylate, acrylamidopropanesulfonic acid, methylolacrylamide or the sodium salt of vinylsulfonic acid.

The polymers of the coating are preferably made up of one or more of the monomers styrene, butadiene, acrylic acid, methacrylic acid, C₁₋₄-alkyl acrylates, C₁₋₄-alkyl methacrylates, acrylamide, methacrylamide and methylolacrylamide.

Binders suitable for the polymer coating are, in particular, acrylate resins which are preferably applied as aqueous polymer dispersions to the foam particles, if appropriate together with hydraulic binders based on cement, lime-cement or gypsum plaster. Suitable polymer dispersions are, for example, obtainable by free-radical emulsion polymerization of ethylenically unsaturated monomers such as styrene, acrylates or methacrylates, as described in WO 00/50480.

Particular preference is given to pure acrylates or styrene-acrylates which are made up of the monomers styrene, n-butyl acrylate, methyl methacrylate (MMA), methacrylic acid, acrylamide or methylolacrylamide.

The polymer dispersion is prepared in a manner known par se, for instance by emulsion, suspension or dispersion polymerization, preferably in an aqueous phase. It is also possible to prepare the polymer by solution or bulk polymerization, comminute it if appropriate and subsequently disperse the polymer particles in water in a customary way. The initiators, emulsifiers or suspension aids, regulators or other auxiliaries customary for the respective polymerization process are used in the polymerization; and the polymerization is carried out continuously or batchwise at the temperatures and pressures customary for the respective process in conventional reactors.

The polymer coating can also comprise additives such as inorganic fillers, e.g. pigments, or flame retardants. The proportion of additives depends on their type and the desired effect and in the case of inorganic fillers is generally from 10 to 99% by weight, preferably from 20 to 98% by weight, based on the additive-comprising polymer coating.

The coating mixture preferably comprises water-binding substances such as water glass. This leads to better or more rapid film formation from the polymer dispersion and thus to fast curing of the foam molding.

The polymer coating preferably comprises flame retardants such as expandable graphite, borates, in particular zinc borates, melamine compounds or phosphorous compounds or intumescent compositions which under the action of high temperatures, generally above 80-100° C., expand, swell or foam and thus form an insulating and heat-resistant foam which protects the thermally insulating foam particles underneath it against fire and heat. The amount of flame retardants or intumescent compositions is generally to 2 to 99% by weight, preferably from 5 to 98% by weight, based on the polymer coating.

When flame retardants are used in the polymer coating, it is also possible to achieve sufficient fire protection when using foam particles which comprise no flame retardants, in particular no halogenated flame retardants, or to make do with relatively small amounts of flame retardant since the flame retardant in the polymer coating is concentrated on the surface of the foam particles and forms a solid network under the action of heat or fire.

The polymer coating particularly preferably comprises intumescent compositions which comprise chemically bound water or eliminate water at temperatures above 40° C., e.g., alkali metal silicates, metal hydroxides, metal salt hydrates and metal oxide hydrates, as additives.

Foam particles provided with this coating can be processed to produce foam moldings which have increased fire resistance and display a burning behavior corresponding to class B in accordance with DIN 4102.

Suitable metal hydroxides are, in particular, those of groups 2 (alkali metals) and 13 (boron group) of the Periodic Table. Preference is given to magnesium hydroxide and aluminum hydroxide. The latter is particularly preferred.

Suitable metal salt hydrates are all metal salts in which water of crystallization is incorporated in the crystal structure. Analogously, suitable metal oxide hydrates are all metal oxides which comprise water of crystallization incorporated in the crystal structure. The number of molecules of water of crystallization per formula unit can be the maximum possible or below this, e.g. copper sulfate pentahydrate, trihydrate or monohydrate. In addition to the water of crystallization, the metal salt hydrates or metal oxide hydrates can also comprise water of constitution.

Preferred metal salt hydrates are the hydrates of metal halides (in particular chlorides), sulfates, carbonates, phosphates, nitrates or borates. Examples of suitable metal salt hydrates are magnesium sulfate decahydrate, sodium sulfate decahydrate, copper sulfate pentahydrate, nickel sulfate heptahydrate, cobalt(II) chloride hexahydrate, chromium(III) chloride hexahydrate, sodium carbonate decahydrate, magnesium chloride hexahydrate and the tin borate hydrates. Magnesium sulfate decahydrate and tin borate hydrates are particularly preferred.

Further possible metal salt hydrates are double salts or alums, for example those of the general formula: M^{I}M^{III}(SO₄)₂.12H₂O. M^{I} can be, for example, potassium, sodium, rubidium, cesium, ammonium, thallium or aluminum ions. M^{III} can be, for example, aluminum, gallium, indium, scandium, titanium, vanadium, chromium, manganese, iron, cobalt, rhodium or iridium.

Suitable metal oxide hydrates are, for example, aluminum oxide hydrate and preferably zinc oxide hydrate or boron thoxide hydrate.

A preferred polymer coating can be obtained by emitting
from 40 to 80 parts by weight, preferably from 50 to 70 parts by weight, of a water glass solution having a water content of from: 40 to 90% by weight, preferably from 50 to 70% by weight,
from 20 to 60 parts by weight, preferably from 30 to 50 parts by weight, of a water glass powder having a water content of from 0 to 30% by weight, preferably from 1 to 25% by weight, and
from 5 to 40 parts by weight, preferably from 10 to 30 parts by weight, of a polymer dispersion having a solids content of from 10 to 60% by weight, preferably from 20 to 50% by weight,
or by mixing
from 20 to 95 parts by weight, preferably from 40 to 90 parts by weight, of an aluminum hydroxide suspension having an aluminum hydroxide content of from 10 to 90% by weight, preferably from 20 to 70% by weight,
from 5 to 40 parts by weight, preferably from 10 to 30 parts by weight, of a polymer dispersion having a solids content of from 10 to 60% by weight, preferably from 20 to 50% by weight.

In the process of the invention, the pressure can be generated, for example, by reducing the volume of the mold by means of a movable punch. In general, a pressure in the range from: 0.5 to 30 kg/cm² is set here. The mixture of coated foam particles is for this purpose placed in the opened mold. After closing the mold, the foam particles are pressed by means of the punch, with the air between the foam particles escaping and the volume of the interstices being reduced. The foam particles are joined by means of the polymer coating to form the foam molding.

The mold is configured in accordance with the desired geometry of the foam body. The degree of fill depends, inter alia, on the desired density of the future molding. In the case of foam boards, it is possible to use a simple box-shaped mold. Particularly in the case of more complicated geometries, it can be necessary to compact the particles introduced into the mold and in this way eliminate undesirable voids. Compaction can be achieved, for example, by shaking of the mold, tumbling motions or other suitable measures.

To accelerate bonding, hot air can be injected into the mold or the mold can be heated. According to the invention, no steam is introduced into the mold, so that no water-soluble constituents of the polymer coating of the foam particles are washed out and no condensate water can form in the interstices. However, any desired heat transfer media such as oil or steam can be used for heating the mold. The hot air or the mold is for this purpose advantageously heated to a temperature in the range from 20 to 120° C., preferably from 30 to 90° C.

As an alternative or in addition, sintering can be effected with the aid of microwave energy radiated into the mold. Here, microwaves in the frequency range from 0.85 to 100 GHz, preferably from 0.9 to 10 GHz, and irradiation times of from 0.1 to 15 minutes are generally used.

When hot air having a temperature in the range from 80 to 150° C. is used or microwave energy is radiated into the mold, a gauge pressure of from 0.1 to 1.5 bar is usually generated, so that the process can also be carried out without external pressure and without reducing the volume of the mold. The internal pressure generated by the microwaves or relatively high temperatures allows the foam particles to expand further easily so that they can fuse together themselves as a result of softening of the foam particles in addition to conglutination via the polymer coating. This results in the interstices between the foam particles disappearing. To accelerate bonding, the mold can in this case too be additionally heated as described above by means of a heat transfer medium.

Double belt units as are used for producing polyurethane foams are also suitable for continuous production of the foam molding of the invention. For example, the prefoamed and coated foam particles can be placed continuously on the lower of two metal belts, which may, if appropriate, have perforations, and be processed with or without compression by the metal belts which come together to produce continuous foam boards. In one embodiment of the process, the volume between the two belts is gradually decreased, as a result of which the product is compressed between the belts and the interstices between the foam particles disappear. After a curing zone, a continuous board is obtained. In another embodiment, the volume between the belts can be kept constant and the belts can run through a zone with hot air or microwave radiation in which the foam particles foam further. Here too, the interstices disappear and a continuous board is obtained. It is also possible to combine the two continuous embodiments of the process.

The thickness, length and width of the foam boards can vary within wide limits and is limited by the size and closure force of the tool. The thickness of the foam boards is usually from 1 to 500 mm, preferably from 10 to 300 mm.

The density of the foam moldings measured in accordance with DIN 53420 is generally from 10 to 120 kg/m³, preferably from 20 to 90 kg/m³. The process of the invention makes it possible to obtain foam moldings having a uniform density over the entire cross section. The density of the surface layers corresponds approximately to the density of the inner regions of the foam molding.

The process of the invention is suitable for producing simple or complex foam moldings such as boards, blocks, tubes, rods, profiles, etc. Preference is given to producing boards or blocks which can subsequently be sawn or cut to give boards. They can, for example, be used in building and construction for insulating exterior wails. They are particularly preferably used as core layer for producing sandwich elements, for example structural insulation panels (SIPs) which are used for the construction of cooistores or warehouses.

Further possible uses are pallets made of foam as a replacement for wooden pallets, ceiling panels, insulated containers, mobile homes. When provided with flame retardant, these are also suitable for airfreight.

### EXAMPLES

Preparation of coating mixture B1:

40 parts of water glass powder (Portil N) were added a little at a time while stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 10 parts of an acrylate dispersion (Acronal S790, solids content: about 50%) were subsequently stirred in.

Preparation of coating mixture B2:

40 parts of water glass powder (Portil N) were added a little at a time while stirring to 60 parts of a water glass solution (Woellner sodium silicate 38/40, solids content: 36%, density: 1.37, molar ratio of SiO₂:Na₂O=3.4) and the mixture was homogenized for about 3-5 minutes. 20 parts of an acrylate dispersion (Acronal S790, solids content: about 50%) were subsequently stirred in.

Polystyrene foam particles I (density: 10 g/l)

Expandable polystyrene (Neopor® 2200 from BASF Aktiengesellschaft, bead size of the raw material: 1.4-2.3 mm) was prefoamed to a density of about 18 g/l on a continuous prefoamer. After an intermediate storage time of about 4 hours, it was foamed further to the desired density on the same prefoamer. The prefoamed polystyrene particles had a particle size in the range from 6 to 10 mm.

Polystyrene foam particles II (density: 15 g/l)

Expandable polystyrene (Neopor® 2200 from BASF Aktiengesellschaft, bead size of the raw material: 1.4-2.3 mm) was prefoamed to a density of about 15 g/l on a continuous prefoamer.

Pressing with reduction in volume:

### Example 1

The polystyrene foam particles I were coated with the coating mixture B1 in a weight ratio of 1:4 in a mixer. The coated polystyrene foam particles were introduced into a Teflon-coated mold which had been heated to 70° C. and pressed by means of a punch to 50% of the original volume. After curing at 70° C. for 30 minutes, the foam molding was removed from the mold. To condition it further, the molding was stored at ambient temperature for a number of days. The density of the stored molding was 78 g/l.

### Example 2

Example 1 was repeated using recycled expanded polystyrene foam material which had a mean density of 18 g/l and had been coated with the coating mixture B2 in a weight ratio of 1:2 as polystyrene foam particles. The density of the stored molding was 78 g/l.

### Example 3

The polystyrene foam particles II were coated with the coating mixture B2 in a weight ratio of 1:2 in a mixer. The coated polystyrene foam particles were introduced into a Teflon-coated mold and hot air (110° C., 0.8 bar gauge pressure) were injected through closable slits. The foam particles expanded further and fused together to form a foam block which was removed from the mold after 5 minutes. To condition it further, the molding was stored at ambient temperature for a number of days. The density of the stored molding was 45 g/l.

Pressing with hot air and reduction in volume

### Example 4

The polystyrene foam particles II were coated with the coating mixture B2 in a weight ratio of 1:2 in a mixer. The coated polystyrene foam particles were introduced into a Teflon-coated mold and hot air (110° C., 0.8 bar gauge pressure) were injected through closable slits. At the same time, the volume was reduced by 20% by means of a movable punch. The foam particles expanded further and fused together to form a foam block which was removed from the mold after 5 minutes. To condition it further, the molding was stored at ambient temperature for a number of days. The density of the stored molding was 45 g/l.

Pressing with further foaming by means of microwaves:

### Example 5

The polystyrene foam particles II were coated with the coating mixture in a weight ratio of 1:2 in a mixer. The coated polystyrene foam particles were introduced into a Teflon-coated mold. Under the action of multiply pulsed microwave radiation, the foam particles expanded further and fused together to form a foam block. To condition if further, the demolded molding was stored at ambient temperature for a number of days. The density of the stored molding was 45 g/l.

The foam moldings from Examples 1 to 5 do not drip in the burning test and do not shrink again under the action of heat. They are self-extinguishing and meet the requirements of the burning test B2 or E.

Sandwich elements having metal covering layers were produced from the foam boards from Examples 1 to 5: boards having dimensions of 600×100×100 mm and a density as indicated in the examples were provided on both sides with in each case a 50 μm thick layer of a polyurethane adhesive. Steel plates having a thickness of 1 mm were applied to the adhesive on each side. The adhesive was allowed to cure at 25° C. for 5 hours.

To test the burning behavior in the sandwich element, the element was fixed horizontally (metal surfaces above and below) and a gas burner was placed under the board. The gas flame of the burner was directed at the middle of the underside of the board, the flame had a height of about 5 cm and a flame temperature of about 600° C. The distance from the tip of the flame to the underside of the board was 2 cm.

Testing of the burning behavior indicated that after the flame had burned for 30 minutes only a small part of the polystyrene foam between the metal plates had melted. The mechanical stability of the board was retained. The polystyrene foam did not drip and did not ignite. Smoke formation was very slight.

Comparative Experiment 1—Use of Steam for Foaming;

The polystyrene foam particles I were coated with the coating mixture B1 in a weight ratio of 1;4 in a mixer. The coated polystyrene foam particles were introduced into a Teflon-coated mold and treated with steam by means of steam nozzles at 0.5 bar gauge pressure for 30 seconds. The molding was taken from the mold and was stored at ambient temperature for a number of days to condition it further. The density of the stored molding was 50 g/l. The coating was partly washed out by steam condensate and was distributed nonuniformly in the molding, which led to a density gradient from the inside to the outside over the molding. The burning tests indicated poorer flame resistance in the surface region of the molding.

Comparative Experiment 2

Example 1 was repeated with the difference that the punch was not moved and no reduction in volume and no compression therefore took place. The foam particles in the mold were compacted by shaking. To condition it further, the molding was stored at ambient temperature for a number of days. The density of the stored molding was 40 g/l. Only point conglutination of the foam particles was achieved. Owing to the large interstitial volume, the compressive strength and the flexural strength are significantly reduced and the water absorption of the foam board is higher.

1. A process for producing foam moldings, comprising
a) prefoaming of expandable styrene polymers to form foam particles,
b) coating of the foam particles with a polymer solution or aqueous polymer dispersion,
c) introduction of the coated foam particles into a mold and sintering under pressure in the absence of steam.

2. The process according to claim 1, wherein the pressure is generated by reducing the volume of the mold.

3. The process according to claim 1, wherein hot air is injected into the mold.

4. The process according to claim 1, wherein sintering is effected with radiation of microwave energy into the mold.

5. The process according to claim 1, wherein the pressure is in the range from 0.5 to 30 kg/cm².

6. The process according to claim 1, wherein the mold is heated to a temperature in the range from 30 to 90° C.

7. The process according to claim 1, wherein the polymer coating consists of a polymer film which comprises an inorganic filler and has a glass transition temperature in the range from −60 to +60° C.

8. The process according to claim 1, wherein the polymer coating comprises an acrylate resin as binder.

9. The process according to claim 1, wherein the polymer coating comprises alkali metal silicates, metal hydroxides, metal salt hydrates or metal oxide hydrates.

10. The process according to claim 9, wherein the polymer coating is obtained by
mixing from 40 to 80 parts by weight of a water glass solution having a water content of from 40 to 90% by weight,
from 20 to 60 parts by weight of a water glass powder having a water content of from 0 to 30% by weight and
from 5 to 40 parts by weight of a polymer dispersion having a solids content of from 10 to 60% by weight,
or by mixing
from 20 to 95 parts by weight of an aluminum hydroxide suspension having an aluminum hydroxide content of from 10 to 90% by weight,
from 5 to 40 parts by weight of a polymer dispersion having a solids content of from 10 to 60% by weight.

11. The process according to claim 2, wherein hot air is injected into the mold.

12. The process according to claim 2, wherein sintering is effected with radiation of microwave energy into the mold.

13. The process according to claim 3, wherein sintering is effected with radiation of microwave energy into the mold.

14. The process according to claim 2, wherein the pressure is in the range from 0.5 to 30 kg/cm².

15. The process according to claim 3, wherein the pressure is in the range from 0.5 to 30 kg/cm².

16. The process according to claim 4, wherein the pressure is in the range from 0.5 to 30 kg/cm².

17. The process according to claim 2, wherein the mold is heated to a temperature in the range from 30 to 90° C.

18. The process according to claim 3, wherein the mold is heated to a temperature in the range from 30 to 90° C.

19. The process according to claim 4, wherein the mold is heated to a temperature in the range from 30 to 90° C.

20. The process according to claim 5, wherein the mold is heated to a temperature in the range from 30 to 90° C.
